(19) United States
(12) Patent Application Publication
(10) Pub. No.: US 2004/0189847 A1
(43) Pub. Date: Sep. 30, 2004

(54) Video magnification inspection system

(75) Inventors: Mark C. Hogrebe, Millstadt, IL (US); E. William Binder, St. Louis, MO (US); Darryl W. Eschmann, Waterloo, IL (US); Wayne T. Wickerham, Ballwin, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Dazor Manufacturing Corp.

(21) Appl. No.: 10/768,278

(22) Filed: Jan. 30, 2004

Related U.S. Application Data
(63) Continuation-in-part of application No. 29/187,360, filed on Jul. 31, 2003.
(63) Continuation-in-part of application No. 09/520,461, filed on Mar. 8, 2000, now abandoned.

(51) Int. Cl. H04N 5/222

(52) U.S. Cl. 348/333.01

(57) ABSTRACT

A lightweight, portable magnification system for magnified inspection of an object. The magnification system has a compact housing constructed for supporting components of the magnification system, a display mounted on the housing for viewing a magnified image of the object to be inspected, and a camera carried by the housing.

### REFERENCE TO RELATED APPLICATIONS

This application is a continuation-in-part application of Ser. No. 09/520,461 filed Mar. 8, 2000 and of Ser. No. 29/187,360 filed Jul. 31, 2003.

### FIELD OF THE INVENTION

This invention generally relates to magnification systems and more particularly to an improved lightweight, portable magnification system for inspecting small objects.

### BACKGROUND OF THE INVENTION

Looking into the eyepieces of a conventional microscope for the first time is usually not an easy task. Although clarity of image and depth perception are achieved by the experienced user, the beginner may see double images, half moons, and in general have a difficult time coordinating the visual paths. With practice, the visual artifacts disappear and the eyes learn to produce a good stereo image. Although the eyes may adapt to the complex task of looking through eyepieces, it requires continual effort to align and integrate the visual information. Over time, this sustained effort produces fatigue. Physical fatigue in the neck, shoulders, and back develops from holding the head in an exact position to keep the eyes aligned in the precise path of the microscope optics. Visual fatigue results from the eye muscles performing precise coordination of movements and held in an exact position for long periods. Mental fatigue develops from the brain working constantly to integrate and combine information from two separate visual paths to produce a “stereo” image.

The negative impact on the person of prolonged microscope work has been widely discussed, documented, and studied. A quick search of “microscope ergonomics” on the internet shows the extent of the research and dialogue related to health issues associated with the use of conventional microscopes. For example, the Occupational Safety and Health Administration (OSHA) states, “Microscope work is straining both to the visual system and the musculoskeletal system. Microscope operators are forced into an unusual, exacting position, with little possibility to move the head or the body.” Studies indicate that about 80% of microscope users have experienced job-related musculoskeletal disorder (MDS) pain and the that 20% have missed work because of medical problems related to microscope use. The high percentage of health issues has a significant negative impact on employee productivity as well as increasing worker compensation costs. Widespread reports of medical problems and health issues associated with prolonged periods of conventional microscope use suggest that alternative inspections methods are needed.

Video microscopes display magnified images on monitors. Instead of using only light and optics to enlarge an object, video magnifiers use a small image sensing device in combination with optics, light, electronic circuits, and computer software to create magnified images. Various forms of video microscopes have been in use for a number of years in highly technical and specialized fields such as surgery and metrology.

There are four factors driving the need for an improved video microscope in the workplace. The first is the continuing trend to manufacture smaller parts. As instruments and equipment become more compact, the parts that comprise them are smaller and more tightly integrated. The production, assembly, and repair of smaller parts requires magnification because less effort in seeing and decoding visual information results in greater speed, accuracy, and efficiency. Secondly, there is an increased need for quality inspection to reduce defects and to insure error-free procedures in laboratories. Video microscopes enhance many aspects of the quality control process by magnifying defects and documenting with video capture. Third, the increasing age of the workforce demands greater attention to the vision needs of older workers who require significantly more light and magnification than younger employees. Video microscopes offer a user friendly way to provide magnified viewing for older employees. Finally, greater attention is being given to ergonomic issues in order to protect workers' health and reduce medical costs.

Typical video microscope configurations consist of a camera connected to a monitor with a cable. The camera is mounted on a “boom” arm/stand or attached to a conventional microscope. When the camera is on a separate arm, it uses optical lenses mounted in front of the image sensor. Cameras mounted on a conventional microscope use its optics. The monitor displays the magnified images from the camera and can be placed almost anywhere in the workstation. Although there is a lot of flexibility in placing the camera and monitor, their alignment and location may not be user friendly and desirable from an ergonomic standpoint.

Increasing monitor size will make magnified images look larger, but will not improve the image resolution produced by the optics and camera. A video microscope system that uses a large monitor may report high magnification power based on screen size, but may actually have low resolution and poor clarity. The camera and optics determine the image quality and resolution at higher magnification levels.

U.S. Pat. No. 4,922,338 discloses a magnification system in which the display is directly in the line of sight between an operator and a camera focal point on an object being viewed. The display therefore interferes with the operator's directly viewing and manually manipulating the workpiece at the focal point.

U.S. Pat. No. 3,819,855 discloses a video system in which the center of the display is significantly distant from a focal point on an object being viewed. The center of the display is not sufficiently proximate the direct line of sight between the operator and the focal point to permit, with very little eye or head movement, simultaneous viewing of an image on the display and direct viewing of an object at the camera focal point. Also, the focal point of the camera is not aligned substantially directly beneath the center point of the display, which further inhibits simultaneous viewing of an image on the display and direct viewing of an object at the camera focal point, and increases the coordination and effort the operator must exercise to control manual manipulation of the object while viewing it on the display.

### SUMMARY OF THE INVENTION

Among the several objects and features of the present invention may be noted the provision of a magnification system that permits magnified visual inspection of small objects while remaining portable and easy to operate; the provision of such a magnification system that requires less dexterity to operate; the provision of a magnification system which facilitates, with very little eye or head movement, simultaneous viewing of an image on the display and direct viewing of an object at the camera lens focal point; the provision of such a magnification system that is highly portable due to its mirrorless construction and relatively small components; the provision of such a magnification system that functions in low light environments; the provision of such a magnification system that permits magnified visual inspection of small objects with shadow-free lighting; the provision of such a magnification system that permits the viewer to control the amount of light on the object and reduce glare or reflections; the provision of such a magnification system that operates in close proximity to the object to simplify manipulation of the object; the provision of such a magnification system that permits a large viewing area; the provision of such a magnification system that permits increased magnification with the same size viewing area; the provision of such a magnification system that permits simultaneous display of the image on other remote displays; the provision of such a magnification system that permits transfer and recordation of still or moving images of the object; and the provision of such a magnification system that permits positioning of the system in any orientation for achieving the most accurate and comfortable viewing situation.

Briefly, therefore, the invention is directed to a lightweight, portable magnification system for magnified inspection of an object, the magnification system comprising a compact housing constructed for supporting components of the magnification system; a display mounted on the housing for viewing a magnified image of the object to be inspected; a camera carried by the housing; and a lens focal point associated with the camera at which images of the object captured by the camera are in focus. The lens focal point associated with the camera is beneath the display and lies in a plane which is vertical and which is perpendicular to the display.

Other objects and features will be in part apparent and in part pointed out hereinafter.

### BRIEF DESCRIPTION OF THE DRAWINGS

FIG. 1 is a front elevational view of the magnification system;

FIG. 2 is rear elevational view of the magnification system;

FIG. 3 is a top plan view of the magnification system;

FIG. 4 is a bottom plan view of the magnification system;

FIG. 5 is a right elevational view of the magnification system;

FIG. 6 is a perspective view of one embodiment of the magnification system;

FIG. 7 is a perspective view of another embodiment of the magnification system;

FIG. 8 is a top plan view of a controller;

FIG. 9 is a schematic illustration of a lighting system;

FIG. 10 is a perspective view of the x-y table; and

FIG. 11 is a side perspective view of the x-y table with the work surface tilted upward.

Corresponding reference characters indicate corresponding parts throughout several views of the drawings.

### DETAILED DESCRIPTION OF THE PREFERRED EMBODIMENTS

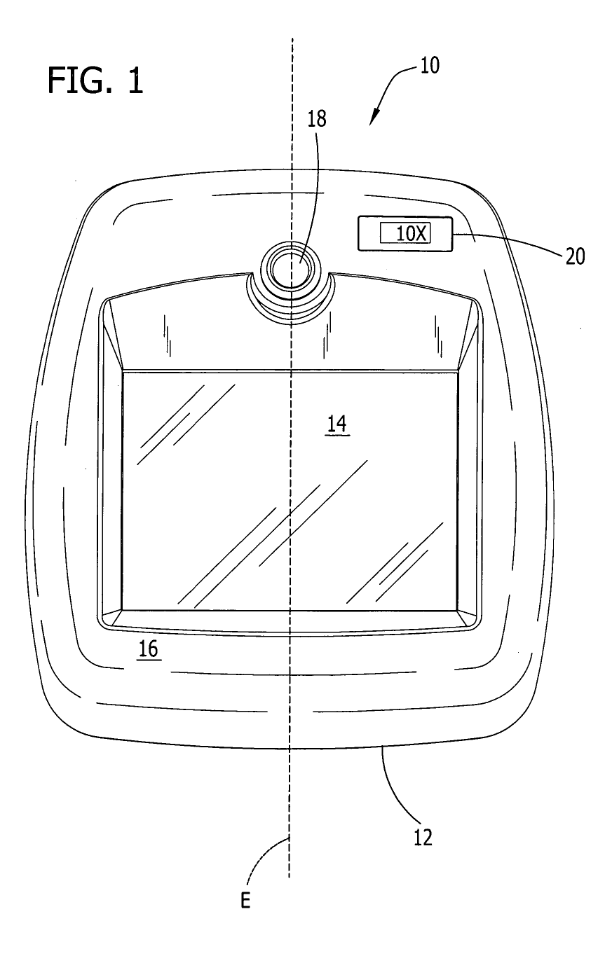

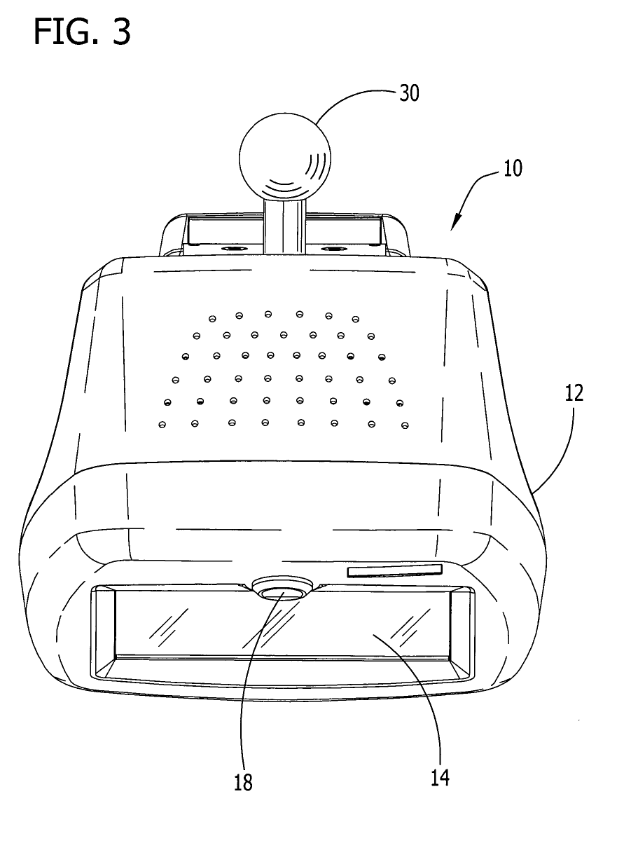

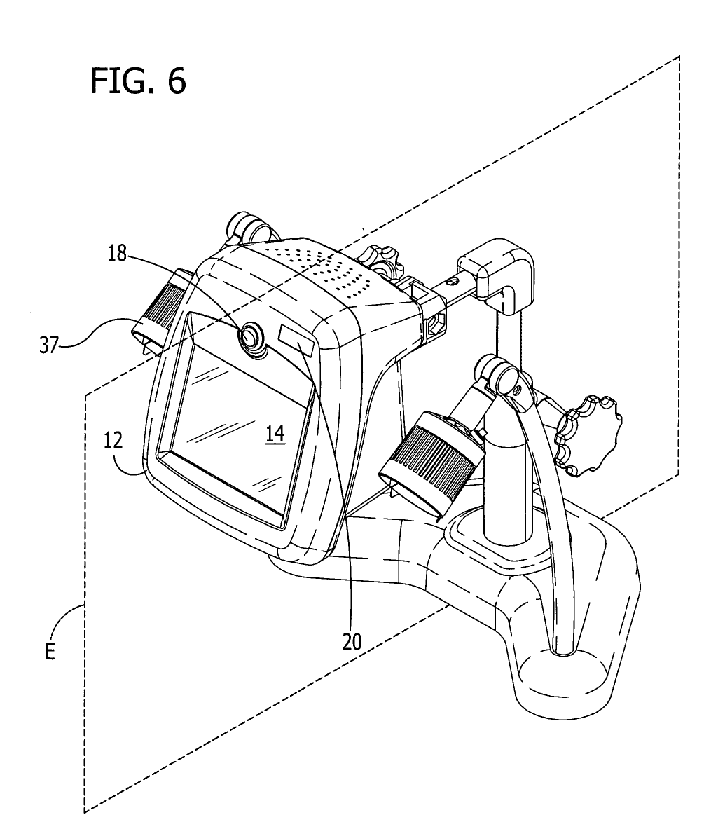

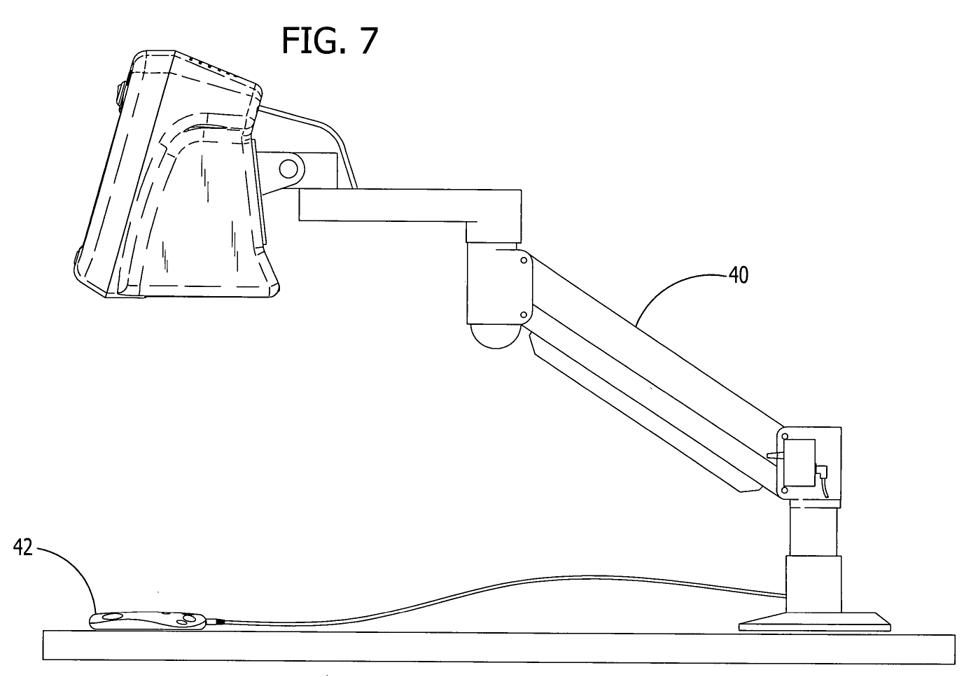

Referring now to the drawings and more specifically to FIGS. 1-5, a lightweight, portable magnification system of the present invention permitting magnified inspection is generally indicated at 10. The lightweight, portable magnification system 10 comprises a housing 12, a display 14, and a camera. The housing 12 is generally rectangular in shape having a front surface 16. On the front of the housing is an on/off switch 18 and an optional digital magnification readout display 20. Extending from the rear of housing 12 is a ball 30 constituting a ball of a ball and socket type mounting device for mounting onto a stand such as in FIG. 6. Alternatively, a flat steel plate can be mounted to the rear of the housing for mounting with an arm as shown in FIG. 7.

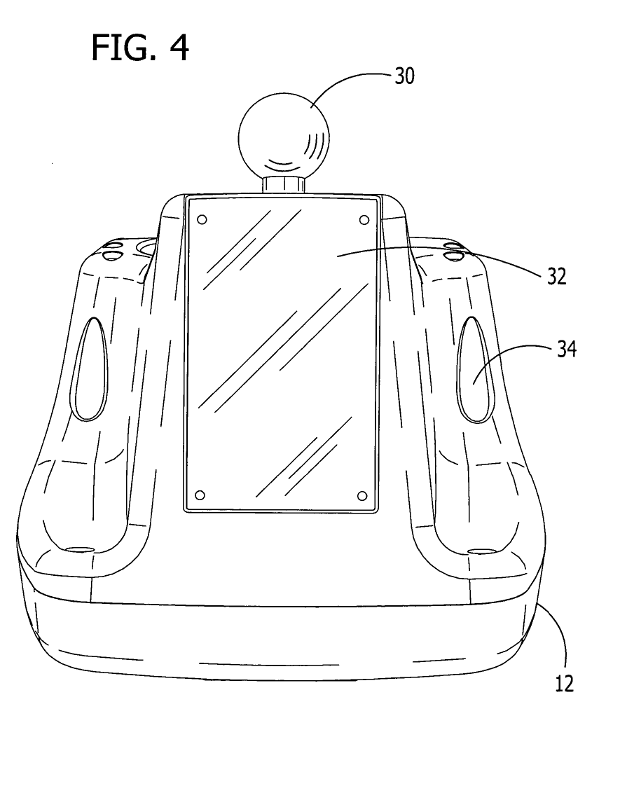

The camera mounts on an internal mechanism (not shown) which mounts to an internal chassis (not shown). The housing 12 encloses the internal mechanism and chassis. The camera has a field of vision directed away from the housing and generally downward to below the housing 12. The camera is enclosed by the housing 12 behind rectangularly shaped view cover 32 (FIG. 4). The camera's field of vision passes through the view cover 32 unobstructed, creating a window through which the camera receives images of the object. The view cover 32 is transparent and protects the camera and internal parts of the magnification system from debris. The camera is designed for focusing on objects a short distance from the camera lens, facilitating display of small objects difficult to view without the aid of a magnification device. Cutouts 34 allow access to screws for assembling and disassembling the housing.

The display 14 is on the front surface 16 of the housing 12 for viewing of a magnified image of the object to be inspected. The screen of the display is selected so as not to be so small, e.g., 2 inches diagonal, as to make distinguishing details on the screen difficult. And while a large 15 to 17 inch diagonal screen may advantageously make the image large, it does so at a cost of occupying valuable work space, and at a cost of having the center of the display positioned a large distance from a camera lens focal point on an object being viewed. As such, with a large screen, the center of the display is well away from the object, such that it is not possible for the viewer to simultaneously view a magnified image on the display and directly view an object at the camera lens focal point, at least not without significant movement of the eyes or head. A preferred screen size is therefore between about 6 and about 8 inches diagonally (a diagonal dimension from a lower left terminal corner to an upper right terminal corner), a size which yields high resolution while displaying a visual field that is comfortable to visually process at an eye-to-screen distance of about 12 to about 18 inches. An eye-to-screen distance of about 12 to about 18 inches is determined by the user's arm reach, so that the user can manipulate an object under the system, and manipulate the system itself. A roughly 6 to 8 inch section of video further corresponds to the size of a section a user can efficiently view at a distance of about 12 to about 18 inches. Accordingly, a larger screen presents more video information than can be efficiently viewed.

One preferred type of display 14 is a flat-screen thin-film transistor (TFT) type display having a 6.4 inch diagonal dimension. TFT display 14 has a relatively wide horizontal viewing angle of greater than about 110°, preferably about 130° or greater. There is a relatively wide vertical viewing angle of greater than about 90°, preferably about 105° or greater. These wide viewing angles allow multiple viewers to view the screen simultaneously from angles other than perpendicular with the display. They also permit a single viewer a wide latitude of comfortable viewing locations, so he can continually reposition himself if so desired. The display preferably has an anti-glare coating thereon. In addition, the TFT display 14 is adapted for adjustment by the viewer to alter the brightness and/or contrast of the image with image adjusters. In a preferred embodiment, for example, the TFT display 14 is available from Sharp Electronics Corporation of Mahwah, N.J. as model number/trade designation LQ064A5CG01.

An especially important aspect of the invention is that the camera and display 14 are carried by the same housing 12. Most significantly, this arrangement keeps the camera conveniently out of the operator's line of sight directly to the object, or from sufficiently close to the line of sight to be distractive. This arrangement also permits alignment of the lens focal point beneath the display as described hereinbelow. These aspects, in combination with the parameters of working distance and screen size, permit the display to be brought into reasonably close proximity to the workpiece, which is critical to the display and the workpiece being positioned within the operator's major field of vision simultaneously. This permits the operator to see his hands and manipulate them with visually assisted coordination while focused on the display. Having the camera and display carried by the housing also facilitates compact storage of the system and easy retrieval, as when the system is carried on arm 40 as shown in FIG. 7.

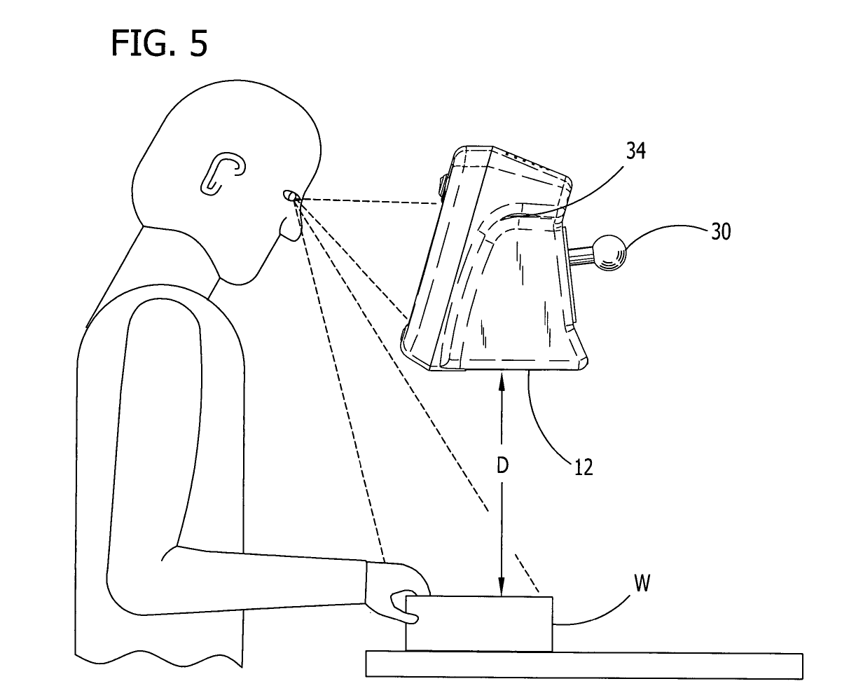

The working distance D (FIG. 5) from the bottom of the housing to the object being viewed, which corresponds approximately to the distance between the camera lens and the camera lens focal point, is sufficient to manipulate the object and optionally perform work on the object while it is being viewed under magnification. Inspection tasks require less working distance than production or repair. A small working distance, such as is typical with optical microscopes, constrains work on the object and manipulation of the object. Too large of a working distance removes the center of the display such that it is significantly distant from the line of sight between the operator and the workpiece, which in turn can result in fatigue and discomfort.

To provide an ideal working distance, in one preferred embodiment the camera has a focal length—constituting the distance between the camera lens and the lens focal point at which objects are in focus—of between about 6 and about 12 inches. In as much as the camera lens is about 1 inch from the bottom of the housing, this yields a working distance D between the bottom of the housing and the lens focal point (which in use is on the workpiece) which is between about 5 and about 11 inches. One especially preferred embodiment employs a camera having a focal length of between about 9 and about 10 inches to provide a working distance of between about 8 and about 9 inches. These are the parameters which have been discovered to provide the ideal combination and balance of parameters to achieve ideal portability, ergonomics, convenience, magnification, and function for most tasks contemplated.

There are alternative embodiments of the invention having a focal length and working distance outside the foregoing ranges. For example, there are situations where a need for much greater magnification dictates a much shorter focal length and a much smaller working distance. In particular, if a significantly greater magnification is required, such as 200×, the current state of magnification technology requires a shorter focal length. While this requires a sacrifice in working distance, many of the other advantages of the invention are still achieved. Accordingly, there are alternative embodiments of the invention in which the focal length is between about 1 inch and about 5 inches, and a working distance of between about 1 and about 4 inches. There are also situations where a need for a much greater working distance dictates a much longer focal length. For example, if there is a need for a working distance of 18 inches in order to accommodate special assembly or repair equipment within the working distance, then the invention is adapted accordingly. In such an alternative embodiment certain of the advantages of the invention are compromised, such as the proximity of the display to the direct line of sight to permit, with very little eye or head movement, simultaneous viewing of a magnified image on the display and direct viewing of an object at the camera lens focal point. Accordingly, there are alternative embodiments of the invention in which the focal length is between about 14 and about 20 inches, and a working distance of between about 13 and about 19 inches.

In absolute terms, in accordance with one preferred embodiment of this invention, the lens focal point of the camera lens—which lens focal point is on the workpiece during operation—and the center of the display are positioned so that they are between about 8 and about 16 inches apart. In an especially preferred embodiment they are between about 10 and 14 inches apart. In one respect this is closely related to the concept of working distance as described above, where working distance is sufficient physical separation between the housing and the lens focal point so there is ample room for the operator to physically manipulate and work on objects under examination. But in another respect it is a distinct aspect related more to visual, rather than physical, convenience. In particular, it has been discovered that this distance between the center of the display and the lens focal point achieves a significant advantage of having the display outside of the direct line of sight between the operator and the lens focal point, while sufficiently proximate this direct line of sight to permit, with very little eye or head movement, simultaneous viewing of a magnified image on the display and direct viewing of an object at the camera lens focal point.

It is a further significant aspect of the present invention that the lens focal point of the camera is aligned substantially directly beneath the display, preferably directly beneath a centerpoint of the display, from the perspective of the operator, to thereby further facilitate simultaneous viewing of a magnified image on the display and direct viewing of an object at the camera lens focal point. In particular, the camera lens has a lens focal point which lies in plane which is vertical and is perpendicular to the display 14. Most preferably, this is centered such that the lens focal point lies in a plane which is a) vertical, b) perpendicular to the display 14, and c) passes through the centerpoint of the display 14, the centerpoint being a lateral centerpoint halfway between the left and right edges of the display. A forward edge of this plane is depicted at E in FIGS. 1 and 6. Shifting this plane laterally to the left an inch (from the straight-on perspective depicted in FIG. 1), or two inches, or three inches, or even all the way until it is roughly aligned with the left edge of the display yields additional planes which satisfy criteria (a) and (b). Similarly, shifting this plane laterally to the right an inch, or two inches, or three inches, or even all the way until it is roughly aligned with the right edge of the display yields additional planes which satisfy criteria (a) and (b). As depicted in FIG. 5, the viewer is able to look down toward his hands and the object being observed, with both the workpiece W and the display 14 on housing 12 positioned within his comfortable field of view. The proximity of object and magnified image in the operator's visual field, and the substantial alignment of the lens focal point directly beneath the center of the display, enhances perspective, comfort, and eye-hand coordination. These advantages are due to the fact that the display 14 and camera are arranged with respect to the housing such that the display is arranged outside the line of sight between the viewer and an object at the camera lens focal point, yet proximate the line of sight between the viewer and the object at the camera lens focal point. This allows the viewer to experience a correlation between movements of the workpiece and movements of the image on the display 14. This correlation creates a natural feel for a viewer, which enhances the usability of the system. The greater the distance and lack of alignment between the object and image, the more difficult it is for the viewer to coordinate eyes and hands, which leads to increased visual effort and fatigue.

An important feature of the invention is that a camera is selected which has a zoom lens which permits changing from between about 1× to about 40× or more without significant telescopy or moving the lens substantially closer to the lens focal point. In particular, the preferred lens zooms primarily by changing the relationship among multiple lenses within the overall lens, and by changing the distance between the lens and its sensor. The distinctions between types of lenses are well understood to those in the lens art and their internal mechanism is not narrowly important to the function of the invention. More important to the invention is that the zooming is achieved without having to adjust the distance of the overall housing to the workpiece, since each time the housing is touched the object may be taken out of focus, and/or vibration is introduced. This aspect is also important to maintaining the compactness of the system, and to preserving the desired working distance. A preferred camera is available from Videology Imaging Solutions of Greenville, R.I. under the camera model number 20Z70422X.

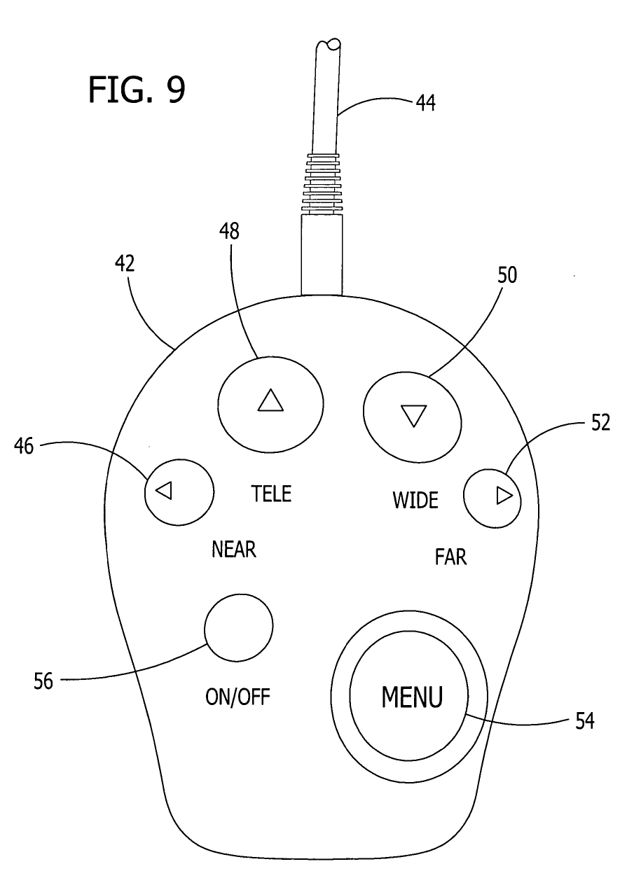

The preferred camera adjusts magnification, such as from about 1× to about 40×, without a change in focal length, and therefore without a change in working distance. This camera includes input controls for adjusting and controlling the system which are located on a multi-function controller 42 (FIGS. 7 and 9) which is portable and independent from the housing 12. The controller is adapted to be positioned in a plane substantially parallel to the plane of the object being viewed, as shown in FIG. 7, and substantially perpendicular to the plane of the display. This orientation renders the controls most accessible during operation. The controller is also adapted to be placed on a working table close to the object being displayed, and within the normal non-peripheral field of vision encompassing the object and the display. This facilitates easy manipulation of the controller without the viewer taking his eyes off the object and display. Controls on the portable multi-function controller include brightness, sharpness, shutter speed, white balance, auto/manual focus, color/black & white, inversion, and mirror image.

An important aspect of selecting a camera having controls on a unit separate from the housing carrying the camera and the display as in the preferred embodiment is that the camera is adjusted without touching the housing. This way, the camera can be zoomed, and the image otherwise manipulated, without risk of moving or vibrating the camera. This allows the image to be manipulated without vibration, and without causing it to move out of focus.

FIG. 9 shows the controller 42 accompanying the preferred commercially available camera. Controls 48 and 50 control zooming in and out. Controls 46 and 52 control manual focus. Control 54 activates display of a menu on the display from which the other controls are used to adjust functions such as brightness, sharpness, shutter speed, white balance, auto/manual focus, color/black & white, inversion, and mirror image. Control 56 turns off only the camera.

FIG. 6 discloses one preferred arrangement for the lighting accompanying the system wherein there are dual lamps 37 on each side of the housing 12 of system 10. An alternative embodiment employs a ring light which employs a loop type bulb wherein the line between the camera lens and an object being examined is encircled by the light bulb. This light is positioned below the camera lens and illuminates the object from all sides by encircling the line between the camera and the workpiece, thereby providing shadow-free viewing, which is important for workpiece objects having steep or sharp surface features prone to casting shadows.

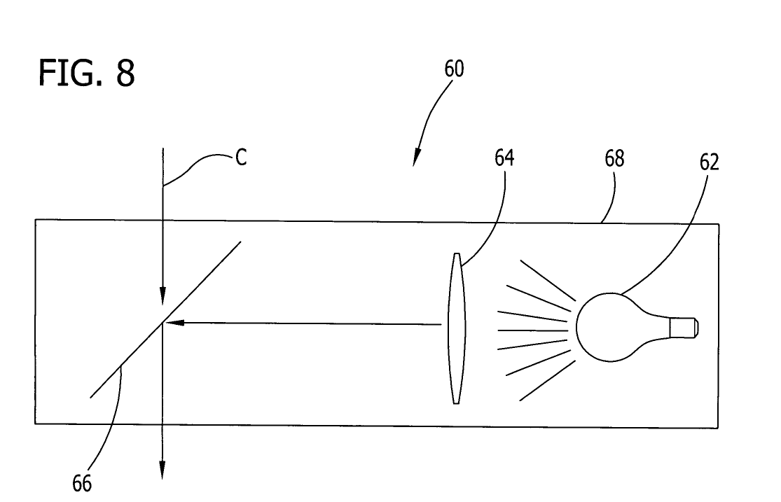

A further alternative embodiment employs a diffuse light source within a light housing interchangeable with the ring light. This diffuse light source is depicted schematically in FIG. 8 and substantially eliminates shine and glare even on highly reflective surfaces, allowing the user to see detail which might otherwise be concealed by glare. These types of light sources are known in the camera art and employ a piece of milky glass or other diffuser 64 as a diffuser in front of a light source 62 whereby light is passed through diffuser 64 to diffuse it. The light is reflected by mirror 66 down onto the object being viewed. These components are housed in a light housing 68. The line of sight between the camera and the lens focal point and object being viewed is depicted as C. In this arrangement, the diffuser 64 can be removed such that a concentrated beam which is employed which, after reflection off mirror 66, is coaxial with the line of sight C of the camera. This permits the illumination of deep holes for shadow-free viewing. In this embodiment, therefore, the system includes an interchangeable lighting system where diffuse/concentrated light source 60 is interchangeable with a ring light source. The respective fixtures are interchangeably attached to the system housing by screws or other appropriate mounting system.

An alternative embodiment employs backlighting in which a relatively flat lighted surface is placed underneath the workpiece, with the workpiece directly between the light source and the camera.

A manual focus control is included on the portable controller for manually adjusting the focus of the camera. The manual focus control is particularly important when a viewer attempts to magnify an object having features at different distances from the camera. The manual focus control allows the viewer to adjust the focus depending upon which feature is most important. The camera also has an electronic sensing mechanism for automatically adjusting the focus. The automatic focusing mechanism is of the type well known to those of ordinary skill in the art and is a component of commercially available cameras. The viewer may switch between manual and automatic focus mode by appropriate operation of the portable controller.

Additionally, there is a control for altering the magnified images on the display 14 between full color, grayscale, and reverse grayscale. Such imaging alterations are important for some viewers who have special viewing requirements. For instance, grayscale may be used when viewing certain objects where color is unimportant and a grayscale image would help increase the contrast between important features. Reverse grayscale imaging may be useful for enlargement of written works where a person has difficulty reading black letters on a white background. The reverse grayscale will allow the viewer to read white letters on a black background. In order to select between these viewing options, there is an an image adjustment option accessible by the portable controller.

Improving upon the prior art magnification systems, the magnification system 10 of the present invention has a total combined weight, exclusive of arm 40 or weighted base in FIG. 6, of less than about 10 pounds, making the system easily portable. This portability is enabled in part due to the compact, mirrorless nature of the image transmission system, as compared to prior systems. The housing 12 is additionally shallow in depth, allowing the viewer to bring the housing and camera close to the object for magnification of the image up to about 40 times its original size on the display 14. The viewer may enlarge the image more by sending the image to a remote viewing device, as described in detail below. For instance, viewing the enlarged image on a 19-inch television will increase the magnification several more times. Incorporating a different remote viewing device, camera, lens system, or display can significantly increase the magnification of the system without departing from the scope of the invention.

As shown in FIG. 7, in one embodiment the system includes an adjustable arm 40 which is adapted for releasably connecting to the housing. The housing is attachable to the arm 40 such that the arm can hold the housing in a self-retaining position selected by the viewer to facilitate viewing. A power cord 41extending from the rear of the housing passes through and is supported by segments of the arm 40 so that the cord does not interfere with orienting the housing and viewing the object. The adjustable arm can also be mounted on a pedestal with caster wheels (not shown) so that the magnification system can conveniently move to different locations.

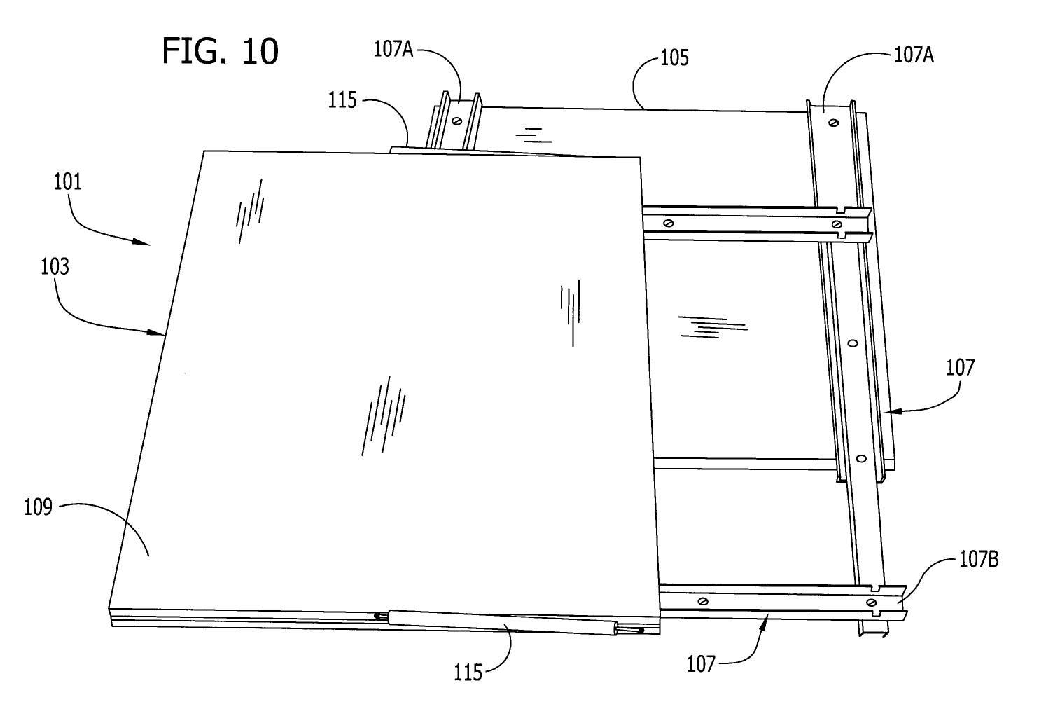

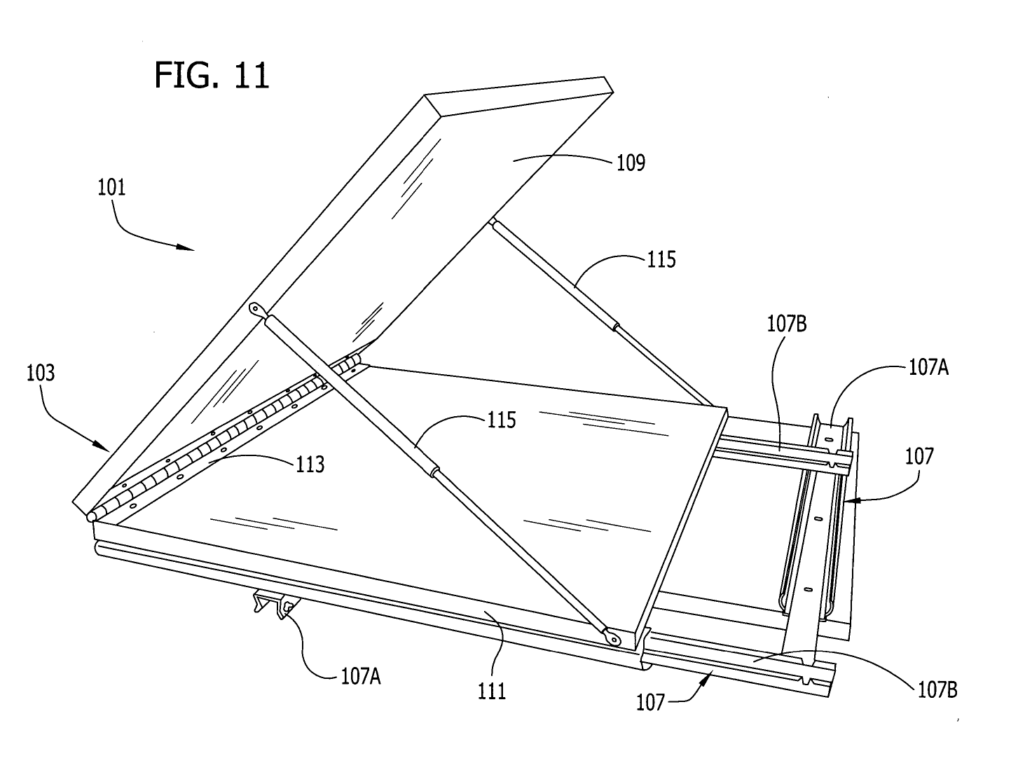

Viewing different portions of the same object may be difficult due to frequent repositioning of the object or housing in a proper position for viewing. An x-y table, generally indicated at 101, as shown in FIGS. 10-11, supports the object for viewing and simplifies moving the selected portion of the object to within the field of vision. The x-y table 101 has a movable work area, generally indicated at 103, and a base 105. The movable work area 103 and base 105 are connected by two pairs of slidable rails, generally indicated at 107. A first pair of slidable rails 107A lie laterally across opposite front and rear edges of the x-y table 101, allowing the movable work area, generally indicated at 103, to slide laterally with respect to the base 105. A second pair of slidable rails 107B are arranged from front to back across opposite side edges of the x-y table 101, allowing the movable work area 103 to slide forward and back with respect to the base 105. The movable work area 103 moves slidably in any horizontal direction because the first pair and second pair of rails 107A, 107B are arranged perpendicular to one another. This arrangement permits the viewer to easily slide the movable work area 103 in any horizontal direction with respect to the base 105, allowing accurate placement of an object beneath the housing and camera. The ease of movement of the slidable rails 107 ensures that little lateral force is required to move an object resting on the x-y table 101 to a desired position for viewing. There are preferably stops (not shown) on the table permitting it to be securely yet releasably retained in a selected position.

In one alternative embodiment, the x-y table 101 is optionally adapted to tilt for altering the angle of the table and object with respect to the housing of the magnification system. The tilting feature allows the viewer to alter the angle at which the camera views the object, providing the viewer with the flexibility to see multiple surfaces of the object. The movable work area 103 of the x-y table 101 comprises two pieces, a work platform 109 and a sliding support 111. The work platform 109 and sliding support 111 are connected via a hinge 113 along a front edge such that the work platform is pivotable upward from horizontal about the hinge. Two air cylinders 115 attach to the edges of the work platform 109 and the sliding support 111 for selectably holding the work platform at a specified angle from the sliding support. Moreover, because sensitive electronic components are often inspected with the magnification system 21, the x-y table 101 is electrostatic discharge (ESD) safe to protect the viewed objects from harmful electrical discharges. In the preferred embodiment, the x-y table 101 is constructed of metal, such as stainless steel, because metal does not hold an electrical charge. Although the x-y table 101 of the preferred embodiment is constructed of metal, other materials that do not hold electrical charges are also envisioned as being within the scope of this invention.

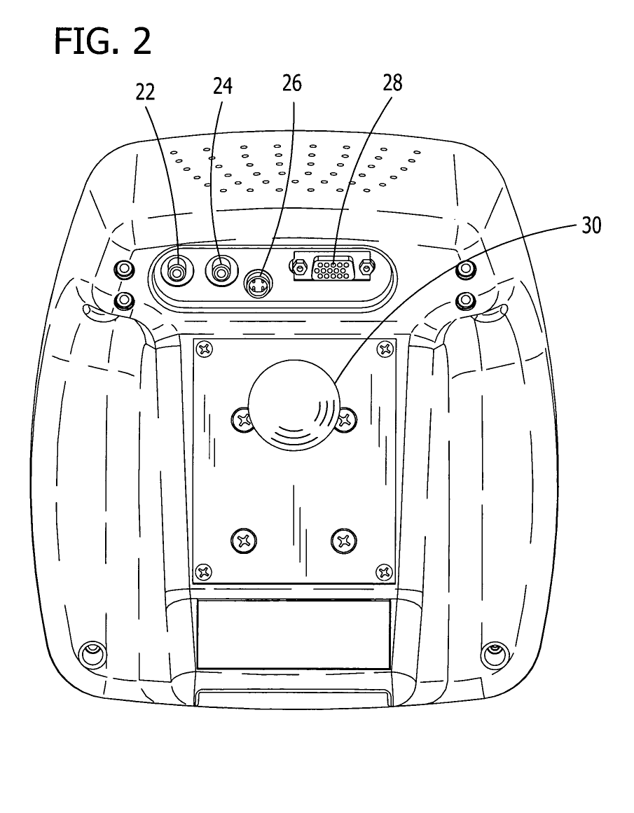

The magnification system comprises a video input and output connectors 22, 24, and 28 (FIG. 2) for connecting the system to a transmission device (not shown) for transmitting a stream of magnified images to or from a remote viewing device. The remote viewing device may be of any compatible type, including a television or computer monitor. The magnification system can also transfer the stream of magnified images to a recording device (not shown) to permanently record the magnified images. The recording device may be of any compatible type including a video recorder, digital recorder, or video capture card. An electrical power input connect 26 is for power input to the system.

The magnification system of the invention addresses many of the ergonomic issues associated with conventional microscope use. The present invention facilitates the use of video microscope on a much wider scale in laboratory and industrial settings. Across many occupations and industries, the health of workers will benefit from the significant ergonomic advantages and ease of use inherent with the invention. Fewer health issues leads to substantial cost savings through increased productivity, decreased workers' compensation claims, and reduced absenteeism.

The invention projects a magnified image on a monitor which frees the person from maintaining the exact body position demanded by the eyepieces of a conventional microscope, thus freeing the posture reduces physical fatigue. With the magnified image on a monitor, the user can observe from various positions and can alter the head, neck, and shoulders to remain comfortable. Many more options for dealing with individual differences become available as well as established ergonomic solutions that are not constrained by a fixed head and shoulder position. For example, chairs, feet, and back supports can be adjusted, users can change postures as often as needed, and prescription glasses can be worn. Handicapped individuals whose disability prevents them from performing work with microscopes may be able to work with magnified images produced with the invention.

The invention renders viewing magnified images as comfortable as using other workstation tasks that use a monitor. Visual fatigue is reduced because the eye muscles do not have to hold exact positions for long periods. Mental fatigue is absent since the brain is not working constantly to produce a stereo image from separate visual paths created by the microscope optics.

Training is easier with the invention because more than one person can view the magnified image. Demonstration of procedures and inspection techniques can be made to groups who view the monitor simultaneously. Everyone sees the same image and observes the live action. Questions can be answered by demonstrating on the spot. Trainees master techniques quicker because the instructor can show and explain as everyone sees exactly what the instructor sees. This basic method of teaching in which the students observe procedures and techniques directly has not always heretofore been available for magnified images.

The invention utilizes electronically processed images that can be saved as movies or still images and used for documentation. Images are stored in a variety of file formats depending on the type of signal from the microscope camera and the software for video capture. Saved images are used for a variety of purposes such as documentation in quality control or importing into software that manages patient records. Magnified images can be captured immediately and then emailed anywhere in the world. Images stored on various media such as small “multi-media cards” can be included with forensic evidence or put in a file folder.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A lightweight, portable magnification system for magnified inspection of an object, the magnification system comprising:
a compact housing constructed for supporting components of the magnification system;
a display mounted on the housing for viewing a magnified image of the object to be inspected;
a camera carried by the housing; and
a lens focal point associated with the camera at which images of the object captured by the camera are in focus;
wherein the lens focal point associated with the camera is beneath the display and lies in a plane which is vertical and which is perpendicular to the display.

2. The magnification system of claim 1 wherein the plane which is vertical and perpendicular to the display and comprises the lens focal point intersects a lateral centerpoint of the display.

3. The magnification system of claim 1 wherein a focal length associated with the camera constituting a distance between the camera lens and the lens focal point at which objects are in focus is between about 6 and about 12 inches and a working distance between the bottom of the housing and the lens focal point is between about 5 and about 11 inches.

4. The magnification system of claim 1 wherein a focal length associated with the camera constituting a distance between the camera lens and the lens focal point at which objects are in focus is between about 1 and about 4 inches and a working distance between the bottom of the housing and the lens focal point is between about 1 and about 5 inches.

5. The magnification system of claim 1 wherein a focal length associated with the camera constituting a distance between the camera lens and the lens focal point at which objects are in focus is between about 14 and about 20 inches and a working distance between the bottom of the housing and the lens focal point is between about 13 and about 19 inches.

6. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches; and
a working distance between the bottom of the housing and the lens focal point is between about 5 and about 11 inches.

7. The magnification system of claim 1 wherein:
the display is outside of a direct line of sight between the operator and the lens focal point; and
the display is sufficiently proximate the direct line of sight between the operator and the lens focal point to permit, with very little eye or head movement, simultaneous viewing of a magnified image on the display and direct viewing of the lens focal point.

8. The magnification system of claim 1 wherein:
a focal length associated with the camera constituting a distance between the camera lens and the lens focal point at which objects are in focus is between about 6 and about 12 inches;
a working distance between the bottom of the housing and the lens focal point is between about 5 and about 11 inches; and the display has a diagonal dimension from a lower left terminal corner to an upper right terminal corner of between about 6 and about 8 inches.

9. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches; and
the display has a diagonal dimension from a lower left terminal corner to an upper right terminal corner of between about 6 and about 8 inches.

10. The magnification system of claim 1 further comprising an x-y table for supporting the object for viewing and moving the object.

11. The magnification system of claim 1 further comprising an x-y table for supporting the object for viewing and moving the object, wherein the x-y table is adapted to tilt for altering the angle of the table and object with respect to the housing.

12. The magnification system as set forth in claim 1 further comprising an x-y table for supporting the object for viewing and moving the object, wherein the x-y table is adapted to tilt for altering the angle of the table and object with respect to the housing and is electrostatic discharge (ESD) safe for use with sensitive electronic components.

13. The magnification system of claim 1 wherein the plane which is vertical and perpendicular to the display and comprises the lens focal point intersects a lateral centerpoint of the display, and wherein the system further comprises an x-y table for supporting the object for viewing and moving the object.

14. The magnification system of claim 1 wherein the plane which is vertical and perpendicular to the display and comprises the lens focal point intersects a lateral centerpoint of the display, and wherein the system further comprises an x-y table for supporting the object for viewing and moving the object, wherein the x-y table is adapted to tilt for altering the angle of the table and object with respect to the housing.

15. The magnification system of claim 1 wherein the plane which is vertical and perpendicular to the display and comprises the lens focal point intersects a lateral centerpoint of the display, and wherein the system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

16. The magnification system of claim 1 wherein a focal length associated with the camera constituting a distance between the camera lens and the lens focal point at which objects are in focus is between about 6 and about 12 inches and a working distance between the bottom of the housing and the lens focal point is between about 5 and about 11 inches, the system further comprising an x-y table for supporting the object for viewing and moving the object.

17. The magnification system of claim 1 wherein a focal length associated with the camera constituting a distance between the camera lens and the lens focal point at which objects are in focus is between about 6 and about 12 inches and a working distance between the bottom of the housing and the lens focal point is between about 5 and about 11 inches, the system further comprising an x-y table for supporting the object for viewing and moving the object, wherein the x-y table is adapted to tilt for altering the angle of the table and object with respect to the housing.

18. The magnification system of claim 1 wherein a focal length associated with the camera constituting a distance between the camera lens and the lens focal point at which objects are in focus is between about 6 and about 12 inches and a working distance between the bottom of the housing and the lens focal point is between about 5 and about 11 inches, the system further comprising an x-y table for supporting the object for viewing and moving the object, wherein the x-y table is adapted to tilt for altering the angle of the table and object with respect to the housing and is electrostatic discharge (ESD) safe for use with sensitive electronic components.

19. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches; and
the system further comprises an x-y table for supporting the object for viewing and moving the object.

20. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches; and
the system further comprises an x-y table for supporting the object for viewing and moving the object, wherein the x-y table is adapted to tilt for altering the angle of the table and object with respect to the housing.

21. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches; and
the system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

22. The magnification system of claim 1 wherein:
the display is outside of a direct line of sight between the operator and the lens focal point;
the display is sufficiently proximate the direct line of sight between the operator and the lens focal point to permit, with very little eye or head movement, simultaneous viewing of a magnified image on the display and direct viewing of the lens focal point; and
the system further comprises an x-y table for supporting the object for viewing and moving the object.

23. The magnification system of claim 1 wherein:
the display is outside of a direct line of sight between the operator and the lens focal point;
the display is sufficiently proximate the direct line of sight between the operator and the lens focal point to permit, with very little eye or head movement, simultaneous viewing of a magnified image on the display and direct viewing of the lens focal point; and
the system further comprises an x-y table for supporting the object for viewing and moving the object, wherein the x-y table is adapted to tilt for altering the angle of the table and object with respect to the housing.

24. The magnification system of claim 1 wherein:
the display is outside of a direct line of sight between the operator and the lens focal point;
the display is sufficiently proximate the direct line of sight between the operator and the lens focal point to permit, with very little eye or head movement, simultaneous viewing of a magnified image on the display and direct viewing of the lens focal point; and
the system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

25. The magnification system of claim 1 wherein:
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and
the system further comprises an x-y table for supporting the object for viewing and moving the object.

26. The magnification system of claim 1 wherein:
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and
the system further comprises an x-y table for supporting the object for viewing and moving the object, wherein the x-y table is adapted to tilt for altering the angle of the table and object with respect to the housing.

27. The magnification system of claim 1 wherein:
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and
the system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

28. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and
the system further comprises an x-y table for supporting the object for viewing and moving the object.

29. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and
the system further comprises an x-y table for supporting the object for viewing and moving the object, wherein the x-y table is adapted to tilt for altering the angle of the table and object with respect to the housing.

30. The magnification system of claim 1 wherein:
the plane which is vertical and perpendicular to the display and comprises the lens focal point intersects a lateral centerpoint of the display;
a focal length associated with the camera constituting a distance between the camera lens and the lens focal point at which objects are in focus is between about 6 and about 12 inches;
a working distance between the bottom of the housing and the lens focal point is between about 5 and about 11 inches;
the display has a diagonal dimension from a lower left terminal corner to an upper right terminal corner of between about 6 and about 8 inches; and the system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

31. A lightweight, portable magnification system for magnified inspection of an object, the magnification system comprising:
a compact housing constructed for supporting components of the magnification system;
a display mounted on the housing for viewing a magnified image of the object to be inspected;
a camera carried by the housing;
a lens focal point associated with the camera at which images of the object captured by the camera are in focus;
a focal length associated with the camera constituting a distance between the camera lens and the lens focal point at which objects are in focus is between about 6 and about 12 inches and a working distance between the bottom of the housing and the lens focal point is between about 5 and about 11 inches.

32. The magnification system of claim 31 further comprising an x-y table for supporting the object for viewing and moving the object.

33. The magnification system of claim 31 further comprising an x-y table for supporting the object for viewing and moving the object, wherein the x-y table is adapted to tilt for altering the angle of the table and object with respect to the housing.

34. The magnification system as set forth in claim 31 further comprising an x-y table for supporting the object for viewing and moving the object, wherein the x-y table is adapted to tilt for altering the angle of the table and object with respect to the housing and is electrostatic discharge (ESD) safe for use with sensitive electronic components.

35. The magnification system of claim 31 wherein:
the display is outside of a direct line of sight between the operator and the lens focal point; and
the display is sufficiently proximate the direct line of sight between the operator and the lens focal point to permit, with very little eye or head movement, simultaneous viewing of a magnified image on the display and direct viewing of the lens focal point.

36. The magnification system of claim 31 wherein:
the display is outside of a direct line of sight between the operator and the lens focal point;
the display is sufficiently proximate the direct line of sight between the operator and the lens focal point to permit, with very little eye or head movement, simultaneous viewing of a magnified image on the display and direct viewing of the lens focal point; and
the magnification system further comprises an x-y table for supporting the object for viewing and moving the object.

37. The magnification system of claim 31 wherein:
the display is outside of a direct line of sight between the operator and the lens focal point;
the display is sufficiently proximate the direct line of sight between the operator and the lens focal point to permit, with very little eye or head movement, simultaneous viewing of a magnified image on the display and direct viewing of the lens focal point; and
the magnification system further comprises an x-y table for supporting the object for viewing and moving the object, wherein the x-y table is adapted to tilt for altering the angle of the table and object with respect to the housing.

38. The magnification system of claim 31 wherein:
the display is outside of a direct line of sight between the operator and the lens focal point; and
the display is sufficiently proximate the direct line of sight between the operator and the lens focal point to permit, with very little eye or head movement, simultaneous viewing of a magnified image on the display and direct viewing of the lens focal point; and
the magnification system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

39. The magnification system of claim 31 wherein the display has a diagonal dimension from a lower left terminal corner to an upper right terminal corner of between about 6 and about 8 inches.

40. The magnification system of claim 31 wherein the display has a diagonal dimension from a lower left terminal corner to an upper right terminal corner of between about 6 and about 8 inches, the magnification system further comprising an x-y table for supporting the object for viewing and moving the object.

41. The magnification system of claim 31 wherein the display has a diagonal dimension from a lower left terminal corner to an upper right terminal corner of between about 6 and about 8 inches, the magnification system further comprising an x-y table for supporting the object for viewing and moving the object, wherein the x-y table is adapted to tilt for altering the angle of the table and object with respect to the housing.

42. The magnification system of claim 31 wherein the display has a diagonal dimension from a lower left terminal corner to an upper right terminal corner of between about 6 and about 8 inches, the magnification system further comprises an x-y table for supporting the object for viewing and moving the object, wherein the x-y table is adapted to tilt for altering the angle of the table and object with respect to the housing and is electrostatic discharge (ESD) safe for use with sensitive electronic components.

43. The magnification system of claim 1 wherein the display is contained within the housing and the camera is carried by said housing.

44. The magnification system of claim 1 wherein the camera is positioned at the bottom of the housing and between the display and the object for inspection.

45. The magnification system of claim 1 wherein the display and the camera are contained within the housing.
